(19) United States
(12) Patent Application Publication
(10) Pub. No.: US 2022/0098770 A1
(43) Pub. Date: Mar. 31, 2022

(54) CUSHION OR PAD DEVICE FORMED FROM VERTICALLY LAPPED NONWOVEN

(71) Applicant: Piana Nonwovens, LLC., Cartersville, GA (US)

(72) Inventors: Mehran Jafari, Cartersville, GA (US); Sang-hoon Lim, Cartersville, GA (US); Andy Hollis, Cartersville, GA (US); Andrea Piana, Cartersville, GA (US); Eric McCann, Cartersville, GA (US); Helias Andriessen, Cartersville, GA (US)

(21) Appl. No.: 17/471,233

(22) Filed: Sep. 10, 2021

Related U.S. Application Data
(60) Provisional application No. 63/083,516, filed on Sep. 25, 2020.

(51) Int. Cl. D04H 1/4382; D04H 1/435; B60N 2/64; B63B 29/04; B64D 11/06

(52) U.S. Cl. CPC D04H 1/43828; D04H 1/435; B60N 2/64; B63B 2029/043; B64D 11/06; D10B 2505/12; B63B 29/04

(57) ABSTRACT

A cushion or pad device is provided. The device comprises at least one layer of nonwoven material defining a volume with length, width, and depth dimensions, wherein the vertically lapped nonwoven material comprises at least one bulk fiber, wherein the bulk fiber comprises a thermoplastic polyester; and at least one elastomeric binder fiber. Methods of preparing the cushion or pad device are also provided.

### FIELD OF THE INVENTION

The present invention generally pertains to replacing foam materials in cushions or pads, such as the cushions or pads used in vehicular seating such as automobiles, trucks, airplanes and boats, with vertically lapped perpendicularly laid nonwovens, and particularly to the constituents of a vertically lapped nonwoven material which would allow them to recover a thickness dimension after a person sits on the cushion or pad.

### BACKGROUND

The vast majority of seats in the automotive and aerospace industry in the E.U. and U.S. markets are made with different layers of foam that provide comfort to its users. Conventional foams, like polyurethane (PU) foams and latex foams, have a relatively high density, high weight, are not breathable, and are not environmentally friendly.

The high weight of some of the foams used in seats increases the transport weight, and thus directly decreases the fuel economy of automobiles and airplanes. The high density and the lack of airflow and breathability of conventionally used foams results in passenger heat build-up while using the seats. This increases passenger discomfort, which often leads to increased air conditioner use. This in turn, significantly increases fuel consumption and negatively impacts fuel economy.

Moreover, conventional foams used in seat assembly often contain elements that are toxic and harmful to the environment during production, during the product lifetime, and at the end of the product lifetime. PU foams can emit volatile organic compounds (VOC), like isocyanide which are harmful to human health. Moreover, PU foams are not recyclable.

Foam replacements that overcome the aforementioned disadvantages are needed.

### SUMMARY

The present disclosure provides a lightweight fiber-based foam replacement (vertically lapped nonwoven) that is 10-60% lighter than conventional foams and provides comfort with sufficient durability and recovery ability to be satisfactory for use as all or part of a cushion used, for example, for seating on an aircraft, boat, automobile, or truck. By recovery ability, it is meant that the cushion or pad will return to at least 80% or 90% of its initial thickness dimension after it is sat on or otherwise has compressive weight applied to it. The compressive response can be measured by standardized testing procedures such as the compression set test set forth in ASTM 3574-D. Compression set tests are widely used by different industries such as automotive and aviation to ensure a seat cushion would return to its original thickness following compression forces over a long period of time. Unlike PU foam, the fiber-based foam replacement is breathable and has excellent airflow properties, making it ideal to dissipate heat. The fiber-based foam replacement is far more environmentally friendly and user friendly than the commonly used PU foams. It is free from VOCs, is fully recyclable, and does not suffer discoloration due to oxidation or possess odors found in currently used PU foam seat assemblies.

One aspect of the disclosure provides a cushion or pad device, comprising at least one layer of vertically lapped nonwoven material defining a volume with length, width, and height/depth dimensions, wherein the vertically lapped nonwoven material comprises at least one bulk fiber, wherein the bulk fiber comprises a thermoplastic polyester; and at least one elastomeric binder fiber. As demonstrated by the experiment results below, the chemical and physical nature of the bulk fiber and the elastomeric binder fiber, as well as the blending ratio, and density of the vertically lapped nonwoven, each factor into whether a vertically lapped fiber-based foam replacement is in compliance with a 80% or 90% recovery when tested according to the ASTM 3574-D procedures. Thus, in addition to the breathability offered by a vertically lapped nonwoven, the fiber blend must also demonstrate recoverability in order to be able to provide cushioning comfort in a seating application.

In some embodiments, the particular elastomeric binder fiber plays an important role in the recoverability after compression of the nonwoven material. Preferably, the elastic binder fiber is a bicomponent fiber comprised of a core and sheath, wherein the core is polybutylene terephthalate (PBT) and the sheath is a co-polymer comprising polytetramethylene terephthalate isophthalate and polytetramethylene oxidepolycondensate. In this application, the elastomeric binder fiber constitutes 5-50% by weight of the at least one vertically lapped nonwoven, while the bulk fiber, which may be a polyester, constitutes 50-95% by weight of the vertically lapped nonwoven.

In other embodiments, the particular bulk fiber plays an important role in the recoverability after compression of the nonwoven material. Preferably, the bulk fiber is the thermoplastic polyester polycyclohexylenedimethylene terephthalate (PCT), and it constitutes 70-90% by weight of the vertically lapped nonwoven. In these embodiments, the elastomeric binder fiber is preferably a bicomponent fiber as described above with a core sheath configuration. As discussed above, the core may be polybutylene terephthalate (PBT) and the sheath may be a co-polymer comprising polytetramethylene terephthalate isophthalate and polytetramethylene oxidepolycondensate. However, in variations on this, the sheath, which mainly functions to melt and resolidify when the nonwoven is being made from the fibers can vary. Preferably, the sheath will be a thermoplastic material with a melting point below 200° C.

In some embodiments, the device further comprises at least one additional fiber to alter the aesthetic or texture of the cushion or pad device. In some embodiments, the at least one additional fiber is selected from the group consisting of nylon, acrylic, polyphenylene sulfide fibers (PPS), poly-paraphenylene terephthalamide, poly-meta-phenylene isophthalamide, polyethylene naphthalate (PEN), oxidized polyacrylonitrile (PAN), melamine-formaldehyde fibers, natural fibers (e.g., cotton, jute, etc.), viscose rayon, and lyocell fibers.

In some embodiments, the at least one layer of nonwoven material includes two or more nonwoven layers molded or laminated together. In some embodiments, the basis weight of the at least one layer of nonwoven material is in a range from 300 to 900 GSM. In some embodiments, the height/depth of the at least one layer of nonwoven material is 1 mm to 120 mm. In some embodiments, the length of the nonwoven material is 25 mm to 3000 mm and the width of the nonwoven material is 25 mm to 3000 mm. In some embodiments, the cushion or pad device is shaped in the shape of one or more parts of an automotive or airplane seat cushion.

### BRIEF DESCRIPTION OF THE DRAWINGS

FIG. 1 is a top plan view of an exemplary vertically lapped nonwoven material;

FIG. 2 is a cross-sectional side view of a multilayered pad made from two different v-lapped nonwovens; and

FIG. 3 is a seat cushion form according to some embodiments of the disclosure.

### DETAILED DESCRIPTION

A “nonwoven” is a manufactured sheet, web, or batt of natural and/or man-made fibers or filaments that are bonded to each other by any of several means. Manufacturing of nonwoven products is well described in “Nonwoven Textile Fabrics” in Kirk-Othmer Encyclopedia of Chemical Technology, 3rd Ed., Vol. 16, July 1984, John Wiley & Sons, p. 72˜124 and in “Nonwoven Textiles”, November 1988, Carolina Academic Press. Web bonding methods include mechanical bonding (e.g., needle punching, stitch, and hydro-entanglement), chemical bonding using binder chemicals (e.g., saturation, spraying, screen printing, and foam), and thermal bonding using binder fibers with low-melting points. Two common thermal bonding methods are air heating and calendaring. In air heating, hot air fuses low-melt binder fibers within and on the surface of the web to make high-loft nonwoven. In the calendaring process, the web is passed and compressed between heated cylinders to produce a low-loft nonwoven.

Vertically or perpendicular lapped nonwovens (v-lap) are made by folding or pleating webs of randomly oriented fibers. Laps or folds are oriented in a vertical (Z) direction and provide high resiliency upon compression. In v-lap nonwovens or nonwovens with sections containing v-lap nonwoven material, as fibers are randomly oriented and bonded together, fibers can compress and reduce fiber-to-fiber distance upon compression and go back to original orientation after removal of force. Vertically lapped nonwovens are light weight, porous and highly air permeable.

A “vertical lapper” is sometimes referred to as a “STRUTO” or a “V-LAP”. WO 2015176099 to Cooper, US Patent Application 20080155787 to Cooper, and U.S. Pat. No. 7,591,049 to Cooper each of which are herein incorporated by reference, show examples of machinery which may be used to make vertically lapped nonwovens for use in the invention. Vertically lapped nonwovens are typically lighter in weight than conventional nonwovens (which are generally horizontally lapped) and are very flexible making them easier to mold than conventional nonwovens.

Embodiments of the disclosure provide a cushion or pad device that is useful for seating in the automotive or aerospace industry or other applications such as furniture and bedding. The device comprises at least one layer of vertically lapped nonwoven material defining a volume with length, width, and depth dimensions, wherein the vertically lapped nonwoven material comprises at least one bulk fiber and at least one elastomeric binder fiber.

The bulk fiber may comprise a polyester, such as a thermoplastic polyester, which offers high heat resistance as well as processability, dimensional stability and chemical resistance. Thermoplastic polyesters are products of aromatic dicarboxylic acids and aliphatic diols. Suitable thermoplastic polyesters include, but are not limited to, polycyclohexylenedimethylene terephthalate (PCT), polybutyleneterephthalate (PBT), and polyethyleneterephthalate (PET).

The elastomeric binder fiber may comprise a bicomponent fiber comprising a core and a sheath made of different polymers. In some embodiments, the core comprises polybutylene terephthalate (PBT) and the sheath is a co-polymer comprising polytetramethylene terephthalate isophthalate and polytetramethylene oxidepolycondensate (co-PET) (e.g. as produced by Teijin Limited). As other examples of elastomeric binder fibers, E-PLEX® and EMF type high elastic LMF are commercially available from Toray Chemical Korea Inc. and Huvis Corporation, respectively.

Nonwovens may be made using mechanical bonding, chemical bonding, or thermal bonding techniques. In an exemplary embodiment, hot-air thermal bonding using low-melt binder fiber is employed to manufacture the nonwoven (i.e., the low-melt binder fibers melt at a lower temperature than the melting point or decomposition temperature of the fiber or fiber blend which makes up the nonwoven material and serves to hold the fibers together in the nonwoven). The low-melt binder fibers can be any of those commonly used for thermal bonding which include, but are not limited to, those that melt from 80 to 160° C. In some embodiments, the binder fiber has a melting point below 200° C. The low-melt binder fibers (and in some applications high-melt binder fibers) serve to mix readily with the other fibers of the non-woven, and to melt on application of heat and then to re-solidify on cooling to hold the other fibers in the nonwoven together. In binder fibers having a core-sheath configuration, the sheath melts on application of heat and functions to hold the other fibers of the nonwoven together. In some embodiments, the sheath melts below a temperature of 200° C. and the core does not melt below the temperature of 200° C.

In some embodiments, the vertically lapped nonwoven material comprises 50-95 wt. %, e.g. about 50, 55, 60, 65, 70, 75, 80, 85, 90%, or 95% of the at least one bulk fiber (polyester, such as, polycyclohexylenedimethylene terephthalate (PCT)) and 5-50 wt. %, e.g. about 5, 10, 15, 20, 25, 30, 35, 40, 45, 50 or 55% of the at least one elastomeric binder fiber. In some embodiments, the vertically lapped nonwoven material comprises 83%-87% of the at least one bulk fiber and 13%-17% of the at least one elastomeric binder fiber.

In some embodiments, the cushion or pad further comprises at least one additional fiber, such as fibers to alter the aesthetic or texture of the cushion or pad device. For example, the additional fiber may alter different properties such as color and softness. Exemplary additional fibers include, but are not limited to, nylon, acrylic, Polyphenylene sulfide fibers (PPS), Poly-paraphenylene terephthalamide (Kevlar®), poly-meta-phenylene isophthalamide (Nomex®), Polyethylene naphthalate (PEN), Oxidized Polyacrylonitrile (PAN), melamine-formaldehyde fibers (Basofil®), cotton, and lyocell fibers (Tencel®).

Other fibers which may be used in the practice of the invention include, but are not limited to, glass fibers, basalt fibers, aramid fibers, polyester fibers, flax, wool (which may be obtained, for example, from one of the forty or more different breeds of sheep, and which currently exists in about two hundred types of varying grades), silk, rayon (a man-made fiber that may include viscose rayon and CUPRAMMONIUM RAYON®), acetate (a man-made fiber), acrylic (a man-made fiber), triacetate (a man-made fiber), SPANDEX® (an elastomeric man-made fiber), polyolefin/polypropylene (man-made olefin fibers), microfibers and microdeniers, plant fiber (a textile fiber of plant origin, such as cotton, kapok, jute, ramie or flax), vinyl fiber (a manufactured fiber), alpaca, angora, carbon fiber (suitable for textile use); (t) glass fiber (suitable for textile use), raffia, ramie, vinyon fiber (a manufactured fiber), VECTRAN® fibers (manufactured fiber spun from CELANESE VECTRA® liquid crystal polymer), and waste fiber. Fibers are commercially available from sources known by those of skill in the art, for example, E.I. Du Pont de Nemours & Company, Inc. (Wilmington, Del.), American Viscose Company (Markus Hook, Pa.), Tintoria Piana USA (Cartersville, Ga.), and Celanese Corporation (Charlotte, N.C.).

All fibers described herein may or may not be processed by means of a variety of common techniques used in the textile industry. These techniques include, but are not limited to, alteration of fiber cross section shape, denier, and post-processing techniques like fiber length cutting, finishing, and mechanical crimping for example.

The nonwoven can be formed using fibers that are treated with chemicals (e.g., dyes (for coloring of some or all of the fibers), fire retardant chemicals (e.g., phosphates, sulfates, silicates, etc.), scents (perfumes, etc.), topical additives such as phase change material particles, talc, carbon nanotubes, etc.). Alternatively, the nonwoven and/or the final assembly of a structure created from the nonwoven can be treated after formation with chemicals (e.g., dyes, scents, fire retardant chemicals, addition of microparticles, etc.).

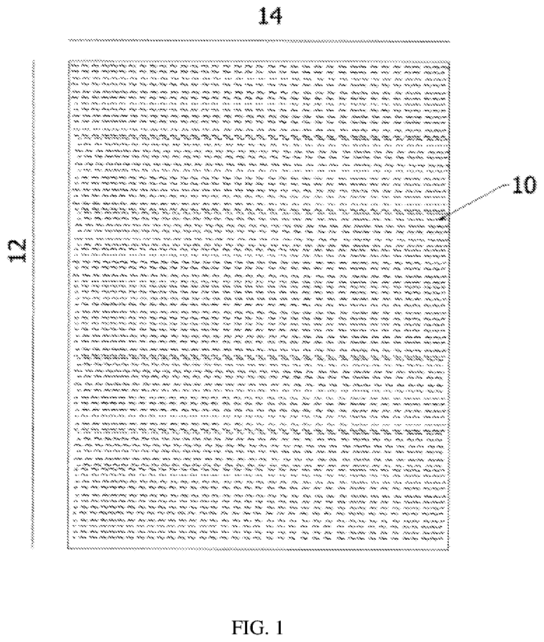

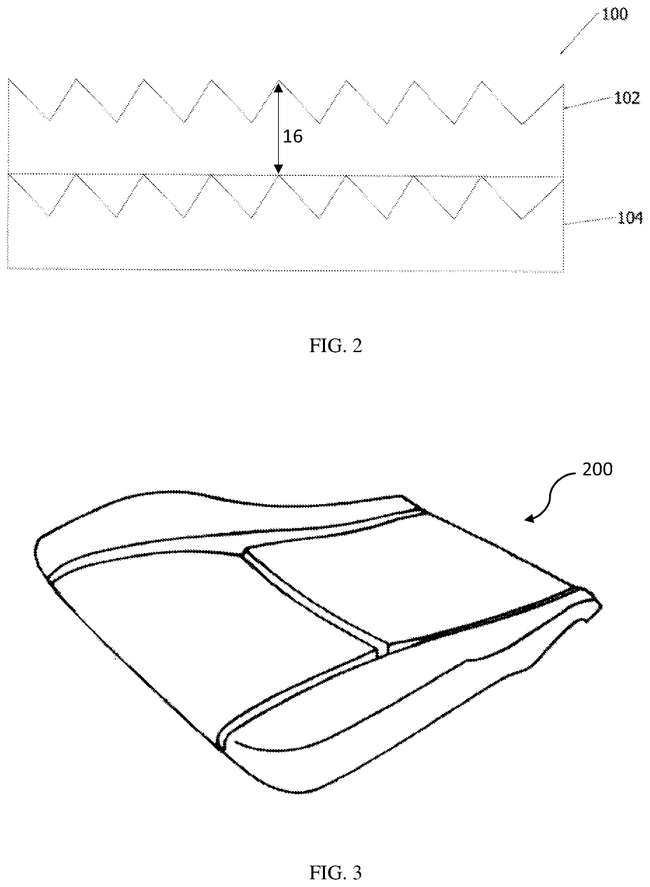

FIG. 1 shows a plan view of an embodiment of the invention drawn to a pad device. In this embodiment, the nonwoven 10 has height 12, width 14, and depth 16 dimensions (see also FIG. 2 which provides a cross-sectional side view of an embodiment of the pad device). These dimensions can be of any size desired depending on the application, e.g. for an automotive or airplane seat cushion, in furniture, or in bedding. For example, the height/depth of the at least one layer of nonwoven material is 1 mm to 120 mm, e.g. 10-100 mm or 30-80 mm. In some embodiments, the length of the nonwoven material is 25 mm to 3000 mm, e.g. 100-2000 mm or 200-1000 mm and the width of the nonwoven material is 25 mm to 3000 mm, e.g. 100-2000 mm or 200-1000 mm.

In some embodiments, the at least one layer of nonwoven material includes two or more nonwoven layers molded or laminated together. FIG. 2 shows a multilayer pad 100 embodiment of the invention. In particular, one v-lapped non-woven 102 is adhered to or otherwise connected to an underlying v-lapped non-woven 104. The multilayer pad 100 is essentially the same as described in connection with FIG. 1, except that a top layer 102 is positioned on an underlying layer. The different layers may have identical or different compositions. For example, the different layers may have varying percentages of bulk and binder fibers or distinct types of bulk and binder fibers.

In some embodiments, the basis weight of the at least one layer of nonwoven material is in a range from 100 to 5000 GSM, e.g. 300 to 900 GSM (e.g. 300, 400, 500, 600, 700, 800, and 900 GSM)

As shown in FIG. 3, the vertically lapped nonwoven may be shaped in the shape of one or more parts of an automotive or airplane seat cushion.

As the majority of fibers in a vertically lapped nonwoven are oriented in the vertical direction, they exhibit excellent resistance to compression and elastic recovery after repeated loading while providing cushion and comfort. The compression set test (also known as ASTM 3574-D) is a standardized test used, for example, in the automotive industry to determine elastic recovery behavior and permanent deformation of material after exposure to compressive force after a prolonged period of time. There are numerous standards for testing compression set properties of automotive seating, and in the most common methods, specimens are compressed to 50% of their initial thickness and placed in the oven at 70° C. for 22 hrs. Subsequently, the standardized test requires a 30-minute cool down period after which the recovery is measured. In particular, one looks at whether the thickness after compression and release recovers to preferably at least 80%, 90%, or more of the initial thickness prior to compression.

The vertically lapped nonwovens described herein are comprised of a fibrous matrix with at least two components: the main (bulk) fiber and an elastomeric binder fiber to create a structure with much higher recovery after a compression set. Compression set testing is used to determine the ability of elastomeric materials to maintain elastic properties after prolonged compressive stress and thermal stress. Specifically, compression set is the ability of a material to recover and resist permanent deformation. The vertically lapped nonwovens described herein are preferably able to recover 80% or more of its original thickness under the conditions of the compression set test, e.g. 80, 85, 90, or 95% or more.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLE

Vertically lapped nonwovens were tested following the ASTM3574-D protocol. The samples were compressed by 50% of their original height and placed in the oven at 70° C. for 22 hours. After a cool down period of 30 minutes, per ASTM3574-D, the recovery and loss of recovery were measured. From the below, it can be seen that Blends 1-3 are example fiber blends suitable for seating applications, but Blends 4-5 are less satisfactory.
Blend 1:

15% PBT-ELK bicomponent binder, 6 denier, 64 mm cut length

85% PCT fiber, 6 deniers, 64 mm cut length

Basis Weight: 300-900 gsm

Loft (thinness): 20-35 mm

Molded density: 0.015-0.06 gr/cm3

Recovery rate according to ASTM 3574: 90%
Blend 2:

30% PBT-ELK bicomponent binder, 6 denier, 64 mm cut length

70% PCT fiber, 6 deniers, 64 mm cut length

Basis Weight: 300-900 gsm

Loft (thinness): 20-35 mm

Molded density: 0.015-0.06 gr/cm3

Recovery rate according to ASTM 3574: 85%
Blend 3:

30% PET-ELK bicomponent binder, 6 denier, 64 mm cut length

70% PCT fiber, 6 deniers, 64 mm cut length

Basis Weight: 300-900 gsm

Loft (thinness): 20-35 mm

Molded density: 0.015-0.06 gr/cm3

Recovery rate according to ASTM 3574: 80%
Blend 4:

30% PBT-ELK bicomponent binder, 6 denier, 64 mm cut length

70% PET fiber, 3 deniers, 51 mm cut length

Basis Weight: 300-900 gsm

Loft (thinness): 20-35 mm

Molded density: 0.015-0.06 gr/cm3

Recovery rate according to ASTM 3574: 72%
Blend 5:

30% PET-ELK bicomponent binder, 6 denier, 64 mm cut length

70% PET fiber, 3 deniers, 51 mm cut length

Basis Weight: 300-900 gsm

Loft (thinness): 20-35 mm

Molded density: 0.015-0.06 gr/cm3

Recovery rate according to ASTM 3574: 66%

While the invention has been described in terms of its preferred embodiments, those skilled in the art will recognize that the invention can be practiced with modification within the spirit and scope of the appended claims. Accordingly, the present invention should not be limited to the embodiments as described above but should further include all modifications and equivalents thereof within the spirit and scope of the description provided herein.

1. A cushion or pad, comprising at least one vertically lapped nonwoven material comprised of at least one bulk fiber and at least one elastomeric binder fiber, wherein the at least one bulk fiber is a polyester which constitutes 50-95% by weight of the at least one vertically lapped nonwoven material, wherein the at least one elastomeric binder fiber is a bicomponent fiber comprised of a core and sheath, wherein the core is polybutylene terephthalate (PBT) and the sheath is a co-polymer comprising polytetramethylene terephthalate isophthalate and polytetramethylene oxidepolycondensate, and wherein the elastomeric binder fiber constitutes 5-50% by weight of the at least one vertically lapped nonwoven, and wherein the at least one vertically lapped nonwoven has an initial thickness dimension, and wherein after the at least one vertically lapped nonwoven is compressed in a thickness direction according to a standardized compression test the at least one vertically lapped nonwoven has a recovery to a thickness of at least 80% of the initial thickness dimension.

2. The cushion or pad of claim 1, wherein the polyester is polycyclohexylenedimethylene terephthalate (PCT).

3. The cushion or pad of claim 2, wherein the at least one bulk fiber constitutes approximately 85% by weight of the at least one vertically lapped nonwoven material, and wherein the elastomeric binder fiber constitutes approximately 15% by weight of the at least one vertically lapped nonwoven material.

4. The cushion or pad of claim 1, wherein the at least one bulk fiber comprises 83%-87% by weight of the at least one vertically lapped nonwoven, and the elastomeric binder fiber constitutes 13%-17% by weight of the at least one vertically lapped nonwoven.

5. The cushion or pad of claim 1, wherein the at least one vertically lapped nonwoven material includes at least one additional fiber selected from the group consisting of nylon, acrylic, polyphenylene sulfide fibers (PPS), poly-paraphenylene terephthalamide, poly-meta-phenylene isophthalamide, polyethylene naphthalate (PEN), oxidized polyacrylonitrile (PAN), melamine-formaldehyde fibers, natural fibers, viscose rayon, and lyocell fibers.

6. The cushion or pad of claim 1, wherein the at least one vertically lapped nonwoven material includes at least two or more vertically lapped nonwoven materials which are joined together.

7. The cushion or pad of claim 1 configured to form at least a part of a seat for a vehicle selected from the group consisting of automobiles, trucks, airplanes, and boats.

8. The cushion or pad of clam 1, wherein the recovery is at least 90%.

9. The cushion or pad of claim 1, wherein the at least one bulk fiber is 70-90% by weight of the at least one vertically lapped nonwoven material, and wherein the elastomeric binder fiber is 10-30% by weight of the at least one vertically lapped nonwoven material.

10. A cushion or pad, comprising at least one vertically lapped nonwoven material comprised of at least one bulk fiber and at least one elastomeric binder fiber, wherein the at least one bulk fiber is polycyclohexylenedimethylene terephthalate (PCT) which constitutes 70-90% by weight of the at least one vertically lapped nonwoven material, wherein the at least one elastomeric binder fiber is a bicomponent fiber comprised of a core and sheath, wherein the sheath melts below a temperature of 200° C. and the core does not melt below the temperature of 200° C., wherein the elastomeric binder fiber constitutes 10-30% by weight of the at least one vertically lapped nonwoven, wherein the at least one vertically lapped nonwoven has an initial thickness dimension, and wherein after the at least one vertically lapped nonwoven is compressed in a thickness direction according to a standardized compression test the at least one vertically lapped nonwoven has a recovery to a thickness of least 80% of the initial thickness dimension.

11. The cushion or pad of claim 10, wherein the core of the elastomeric binder fiber is polybutylene terephthalate (PBT) and the sheath is a co-polymer comprising polytetramethylene terephthalate isophthalate and polytetramethylene oxidepolycondensate.

12. The cushion or pad of claim 11, wherein the at least one bulk fiber constitutes approximately 85% by weight of the at least one vertically lapped nonwoven material, and wherein the elastomeric binder fiber constitutes approximately 15% by weight of the at least one vertically lapped nonwoven material.

13. The cushion or pad of claim 10, wherein the at least one bulk fiber comprises 83%-87% by weight of the at least one vertically lapped nonwoven, and the elastomeric binder fiber constitutes 13%-17% by weight of the at least one vertically lapped nonwoven.

14. The cushion or pad of claim 10, wherein the at least one vertically lapped nonwoven material includes at least one additional fiber selected from the group consisting of nylon, acrylic, polyphenylene sulfide fibers (PPS), poly-paraphenylene terephthalamide, poly-meta-phenylene isophthalamide, polyethylene naphthalate (PEN), oxidized polyacrylonitrile (PAN), melamine-formaldehyde fibers, natural fibers, viscose rayon, and lyocell fibers.

15. The cushion or pad of claim 10, wherein the at least one vertically lapped nonwoven material includes at least two or more vertically lapped nonwoven materials which are joined together.

16. The cushion or pad of claim 10 configured to form at least a part of a seat for a vehicle selected from the group consisting of automobiles, trucks, airplanes, and boats.

17. The cushion or pad of clam 10, wherein the recovery is at least 90%.
